(19) United States
(12) Patent Application Publication
(10) Pub. No.: US 2024/0103145 A1
(43) Pub. Date: Mar. 28, 2024

(54) SENSOR CLEANING DEVICE

(71) Applicants: HYUNDAI MOTOR COMPANY, Seoul (KR); KIA CORPORATION, Seoul (KR)

(72) Inventor: Young Dug Yang, Seoul (KR)

(73) Assignees: HYUNDAI MOTOR COMPANY, Seoul (KR); KIA CORPORATION, Seoul (KR)

(21) Appl. No.: 18/110,217

(22) Filed: Feb. 15, 2023

(30) Foreign Application Priority Data
Sep. 28, 2022 (KR) 10-2022-0122927

(51) Int. Cl. G01S 7/497; B60S 1/54; B60S 1/56; G01S 7/481; G01S 17/931

(52) U.S. Cl. CPC G01S 7/497; B60S 1/54; B60S 1/56; G01S 7/4813; G01S 17/931; G01S 2007/4977

(57) ABSTRACT

A sensor cleaning device includes an environmental sensor and a film element disposed to surround the environmental sensor.

### CROSS-REFERENCE TO RELATED APPLICATION

This application claims under 35 U.S.C. § 119(a) the benefit of priority to Korean Patent Application No. 10-2022-0122927, filed on Sep. 28, 2022, the entire contents of which are incorporated herein by reference.

### BACKGROUND

### (a) Technical Field

The present disclosure relates to a sensor cleaning device.

### (b) Background Art

Recently, a driver assistance system that assists a driver of a vehicle is mounted on a vehicle in order to secure safe driving in various driving situations. In addition to the driver assistance system, research and development is being actively conducted on autonomous driving vehicles that can drive themselves without driver intervention.

For such a driver assistance system or autonomous driving vehicle, various types of environmental sensors capable of detecting the surrounding environment in various ways are required. The environmental sensors mounted in the vehicle may be a radar, a LiDar, and a camera.

Since these sensors are mounted on the outside of the vehicle, a sensing area may easily become dirty by foreign substances, such as dust, rain, snow, etc. Therefore, in order to maintain performance of the sensors, these sensors must be kept clean above a certain level. Accordingly, a contamination detection device for detecting contamination of these sensors and a sensor cleaning system capable of cleaning the sensors when the sensing area is determined to be contaminated based on the detection are provided in the vehicle.

### SUMMARY OF THE DISCLOSURE

The present disclosure has been devised to solve the above problems.

The present disclosure provides a sensor cleaning device capable of efficiently cleaning a sensor, such as a LiDar sensor.

The present disclosure provides a sensor cleaning device that has excellent cleaning power.

The objects of the present disclosure are not limited to the above-described objects. Unmentioned or other objects may be appreciated clearly from the following detailed description by a person those having ordinary skill in the art to which the technical concepts of the present disclosure belong.

In order to achieve the objects of the present disclosure as described above, and to perform the characteristic functions of the present disclosure to be described later, the characteristics of the present disclosure are as follows.

According to some embodiments of the present disclosure, a sensor cleaning device includes an environmental sensor and a film element disposed to surround the environmental sensor.

According to some embodiments of the present disclosure, a sensor cleaning device includes: an environmental sensor; a film element disposed to surround the environmental sensor and to be rotatable with respect to the environmental sensor; and an injection nozzle provided in the environmental sensor and configured to spray a cleaning fluid onto the film element.

### BRIEF DESCRIPTION OF THE DRAWINGS

The above and other features of the present disclosure are now be described in detail with reference to certain examples thereof illustrated in the accompanying drawings, which are given herein below by way of illustration only, and thus are not limitative of the present disclosure, and wherein:

FIG. 1 is a diagram illustrating an example of a configuration of a sensor cleaning system using compressed air;

FIG. 2 is a diagram illustrating a schematic arrangement of environmental sensors and the sensor cleaning system of FIG. 1 installed in a vehicle;

FIG. 3 is a diagram illustrating a LiDar sensor cleaning device according to an embodiment of the present disclosure;

FIG. 4 is an exploded perspective view of the LiDar sensor cleaning device of FIG. 3;

FIGS. 5 and 6 are diagrams illustrating an inner side of portion marked by Si of the LiDar sensor cleaning device in FIG. 3;

FIG. 7 is a perspective view of a LiDar sensor cleaning device according to an embodiment of the present disclosure;

FIG. 8 is a perspective view of the LiDar sensor cleaning device according to an embodiment of the present disclosure taken along line A-A′ in FIG. 7;

FIG. 9 is a front view of the LiDar sensor cleaning device according an embodiment of the present disclosure;

FIG. 10 is a rear side view of a state in which a part of a housing is removed from the LiDar sensor cleaning device of FIG. 9 according to an embodiment of the present disclosure; and

FIG. 11 is a rear side view of the LiDar sensor cleaning device of FIG. 10 according to an embodiment of the present disclosure and illustrates the state in which a part of the housing is removed.

It should be understood that the appended drawings are not necessarily to scale, presenting a somewhat simplified representation of various features illustrative of the basic principles of the disclosure. The specific design features of the present disclosure as shown and described herein, including, for example, specific dimensions, orientations, locations, and shapes will be determined in part by the particular intended application and use environment.

In the drawing figures, reference numbers refer to the same or equivalent parts of the present disclosure throughout the several figures of the drawing.

### DETAILED DESCRIPTION

Specific structural or functional descriptions presented in embodiments of the present disclosure are only exemplified for the purpose of describing the embodiments according to the concept of the present disclosure. The embodiments according to the concept of the present disclosure may be implemented in various forms. In addition, it is to be understood that the present disclosure is not limited to the embodiments described in the present specification. The present disclosure thus includes all modifications, equivalents, and substitutions without departing from the scope and spirit of the present disclosure.

In the present disclosure, terms, such as “first,” “second,” or the like, may be used to describe various components, but these components are not to be construed as being limited by these terms. The terms are used only to distinguish one component from another component. For example, the ‘first’ component may be named the ‘second’ component and the ‘second’ component may also be similarly named the ‘first’ component, without departing from the scope of the present disclosure.

It is to be understood that, when one component is referred to as being “connected to” or “coupled to” another component, one component may be connected directly to or coupled directly to another component or may be connected to or coupled to another component with another component interposed therebetween. On the other hand, it should be understood that, when one element is referred to as being “connected directly to” or “coupled directly to” another element, it is be connected to or coupled to another element without another element interposed therebetween. In addition, other expressions describing a relationship between components, i.e., “between,” “directly between,” “neighboring to,” “directly neighboring to” and the like, should be similarly interpreted.

The same reference numerals denote the same constituent elements throughout the specification. Further, terms used in the present disclosure are for describing various embodiments rather than limiting the present disclosure. Unless otherwise stated, a singular form includes a plural form in the present specification. Components, steps, operations, and/or elements mentioned by terms “comprise” and/or “comprising” used in the present disclosure do not exclude the existence or addition of one or more other components, steps, operations, and/or elements. When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings.

As described above, in order to maintain the performance of environmental sensors detecting the surrounding environment of a vehicle, surfaces of the sensors need to be periodically cleaned. For example, the environmental sensor may be polluted or contaminated by dust, sand, etc., and may be polluted or obscured by raindrops or snow during precipitation.

In particular, in an active autonomous driving vehicle, a vehicle is driven based on information on the surrounding environment, such as traffic lights, pedestrians, road shapes, buildings, and surrounding vehicles recognized by the environmental sensor. When the surface of the environmental sensor is contaminated or obscured, the recognition of the surrounding environment deteriorates or becomes impossible and the active autonomous driving becomes impossible. Therefore, the sensor cleaning system of the vehicle performs an important function to help the environmental sensor clearly recognize the surrounding environment without distortion and enables driving by removing contaminants or substances from the surface of the environmental sensor.

The environmental sensor may be cleaned using a washer fluid or using high-pressure air. In the former, the sensor may be cleaned using the washer fluid, and water on the sensor may be removed by injecting air. In the latter, only the high-pressure air may be used to remove foreign substances from the surface of the sensor.

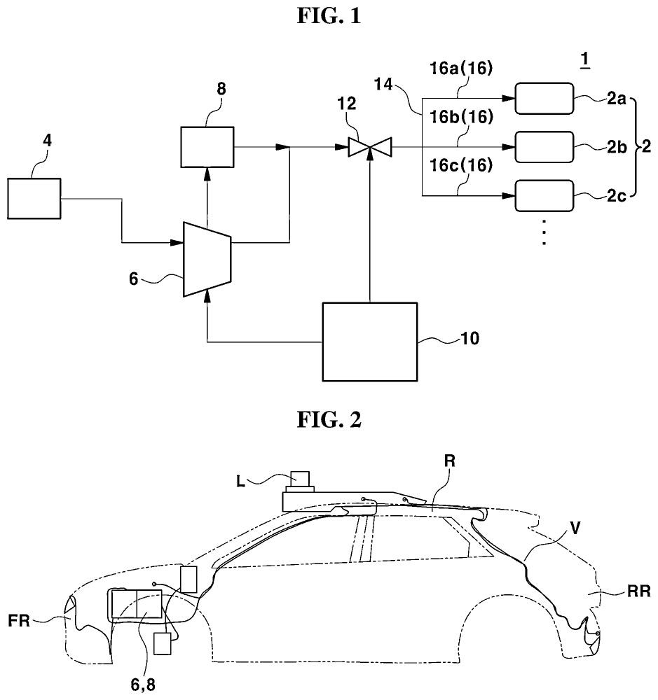

The sensor cleaning system of the latter, so-called air cleaning method in which the environmental sensor is cleaned by compressed air is described with reference to FIGS. 1 and 2. Among the sensor cleaning systems, an air cleaning system 1 is configured to clean the environmental sensor using the compressed air. The air cleaning system 1 performs cleaning by injecting the compressed air onto the surface of the environmental sensor 2. The environmental sensor 2 includes a sensing device such as a LiDar, a radar, or a camera and may be disposed on a front part FR, a rear portion RR, a side portion, and/or a roof R of a vehicle V.

Specifically, air filtered through an air filter 4 provided in the vehicle V is introduced into a compressor 6. Air compressed by the compressor 6 is sprayed onto the surface of the environmental sensor 2 to remove foreign substances on the environmental sensor 2. The environmental sensor 2, in practice, will likely include a plurality of environmental sensors 2a, 2b, and 2c. Three environmental sensors are disclosed in the drawings and the specification, but the number of environmental sensors is not limited thereto and may be increased or decreased.

In addition, the air cleaning system 1 also includes an air tank 8. Air compressed through the compressor 6 may fill the tank 8, or air may be provided in the air tank 8 by an external device. The air in the air tank 8 may be used for cleaning the environmental sensor 2.

A controller 10 of the air cleaning system 1 is configured to operate a valve 12, for example, a solenoid valve, in a preset situation, such as every preset cycle or when the environmental sensor 2 detects contamination or deteriorated performance. Accordingly, the compressed air is directed from the compressor 6 or the air tank 8 into each environmental sensor 2 to clean the environmental sensor 2. The valve 12 may be provided with or integrally formed with a distributor 14 so that compressed air is distributed through a nozzle 16. The nozzle 16 may include a plurality of nozzles 16a, 16b, and 16c provided for each of a plurality of environmental sensors 2 as illustrated in FIG. 2.

In one example, a LiDar sensor L among the environmental sensors 2 is configured to collect signals reflected from the surrounding environment while scanning a wide range while the vehicle V is driven. For this reason, the LiDar sensor L is more likely to be exposed to more contaminated or polluted environments than other environmental sensors 2 because it is positioned in an open form exposed to the environment. Specifically, a large number of nozzles may be required to inject the washer fluid or the compressed air for cleaning of the LiDar sensor L when a range detected by the LiDar sensor L, i.e., a field of view is 180° or more (e.g., 180°, 240°, etc.). Even under these circumstances, the cleaning power may be insufficient. Moreover, the amount of cleaning liquid used must be considered, so a maintenance cycle may need to be shortened.

Accordingly, the present disclosure provides a LiDar sensor cleaning device capable of providing excellent cleaning power while minimizing the number of nozzles for cleaning the LiDar sensor L.

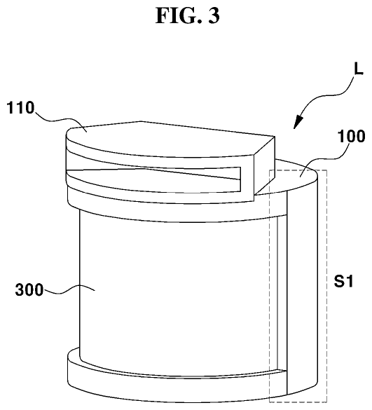

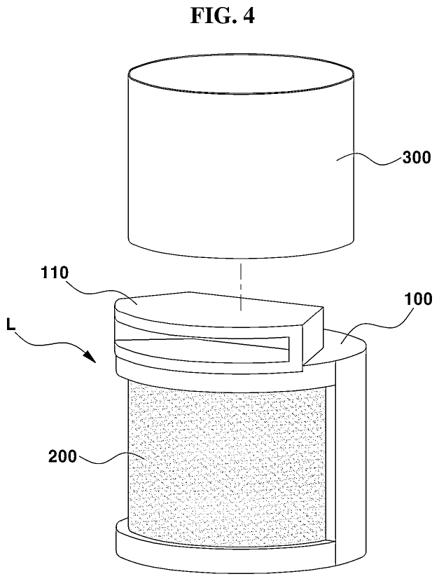

As illustrated in FIGS. 3 and 4, the LiDar sensor cleaning device includes a housing 100 and a film element 300.

The housing 100 is configured to mount or embed at least a part of the LiDar sensor cleaning device according to the present disclosure. The remaining portion of the LiDar sensor L except for a sensing portion 200 of the LiDar sensor L may be surrounded by the housing 100. For example, a rear portion of the LiDar sensor L may be protected by the housing 100. In one implementation, the housing 100 may be integrally formed with or separately formed from the LiDar sensor L.

The film element 300 is mounted on the LiDar sensor L. More specifically, the film element 300 may be inserted into the LiDar sensor L to surround the sensing portion 200 of the LiDar sensor L.

The film element 300 is made of a material that does not affect the performance, such as the sensing performance of the LiDar sensor L. As a non-limiting example, the film element 300 may be made of a polyamide material.

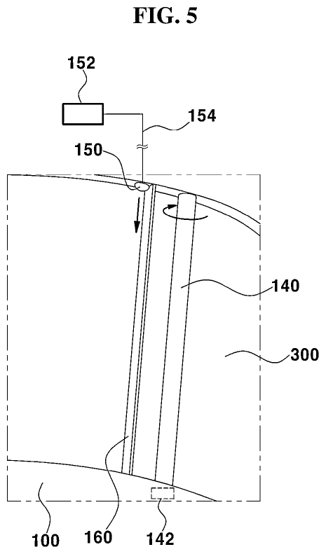

Referring to FIG. 5, the film element 300 is configured to be rotatable. To this end, according to an implementation of the present disclosure, the housing 100 is provided with a rotating element 140. The rotating element 140 is configured to be rotatable with respect to the housing 100 and may rotate the film element 300 by rotation. A rotating element actuator 142 is provided in the housing 100 to provide a rotational force to the rotating element 140. As a non-limiting example, the rotating element 140 may be a roller, and the rotating element actuator 142 may be an electric actuator, such as a motor that rotates the rotating element 140.

The housing 100 is provided with an injection nozzle 150. The injection nozzle 150 is configured to inject the cleaning fluid onto the film element 300. In some implementations, the injection nozzle 150 may be provided at an upper area of the housing 100.

The cleaning fluid may be supplied from a storage 152 to the injection nozzle 150 along a supply line 154. The storage 152 may store the cleaning fluid. The supply line 154 may transport the cleaning fluid from the storage 152 to the injection nozzle 150. As a non-limiting example, the storage 152 may be provided in the LiDar sensor L, the housing 100, or the vehicle V.

According to an implementation of the present disclosure, the housing 100 may be provided with a contact element 160. The contact element 160 may be provided adjacent to the injection nozzle 150. The contact element 160 is configured to wipe the film element 300 through physical contact with the film element 300. In some implementations, the contact element 160 may be formed of as a sponge, a brush, or a rubber element, similar to a vehicle wiper, or the like.

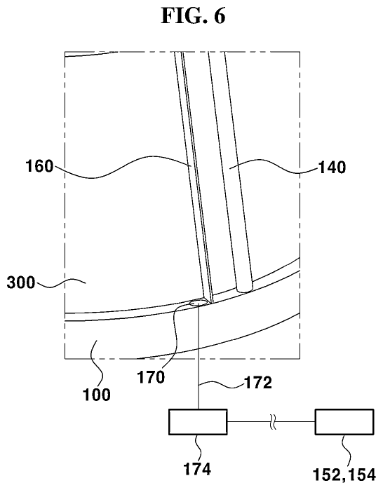

As illustrated in FIG. 6, the housing 100 may be provided with a collector 170. The collector 170 is configured to collect the used cleaning fluid injected onto the film element 300 through the injection nozzle 150. In one implementation, the collector 170 may be provided on a lower side of the housing 100. The cleaning fluid injected from an upper portion of the housing 100 onto the film element 300 through the injection nozzle 150 may flow down by gravity and may be collected in the collector 170.

A recovery line 172 capable of recovering the cleaning fluid collected in the collector 170 may be provided. The recovery line 172 is configured to recover the used cleaning fluid collected in the collector 170 and deliver the recovered cleaning fluid to the storage 152 or merge the recovered cleaning fluid into the supply line 154, and thus, may be reused. The recovery line 172 is provided with a filter element 174, so the cleaning fluid may be filtered, i.e., clean or purified of contaminants, before being delivered to the storage 152 or the supply line 154.

According to an implementation of the present disclosure, the rotating element 140, the injection nozzle 150, and the contact element 160 may be provided inside a rear side of the housing 100.

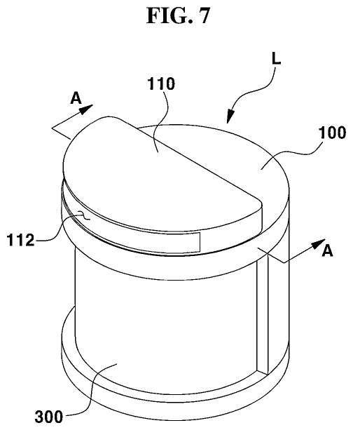

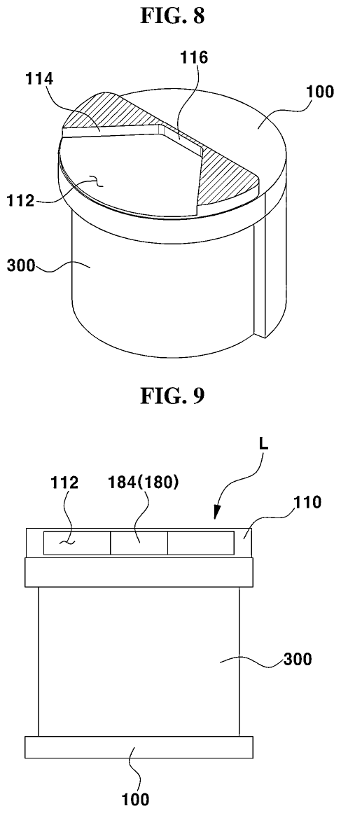

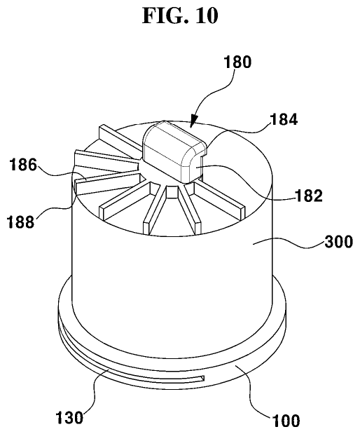

As illustrated in FIGS. 7-9, the housing 100 may include an intake portion 110. The intake portion 110 may extend along a circumference of the housing 100. When the LiDar sensor L is mounted on the vehicle V, the intake portion 110 may be disposed to open toward the front of the vehicle V. For example, the intake portion 110 may be opened in a direction substantially opposite to a direction of the driving air flow so that the driving air flow of the vehicle V may be introduced. In other words, FIGS. 7 and 8 illustrate the state of the LiDar sensor L when viewed from the front to the rear of the vehicle V.

The intake portion 110 may include a distal portion 112, an extension 114, and a proximity portion 116. The distal portion 112 is an outermost side of the intake portion 110 and positioned upstream of the flow direction of the driving air flow toward the LiDar sensor L when a vehicle advances. The driving wind or air flow introduced into the distal portion 112 moves along the extension 114 in the intake portion 110. The area of the intake portion 110 may be formed to decrease from the distal portion 112 to the extension 114, i.e., as the intake portion 110 goes downstream in the driving air flow direction. A cross-section of the intake portion 110 may have an approximately sector shape. The extension 114 extends to the proximity portion 116, and an opening area of the proximity portion 116 in the intake portion 110 is formed to be smallest. The proximity portion 116 is configured to be in fluid communication with a nozzle assembly 180 disposed within the housing 100.

As illustrated in FIG. 10, the nozzle assembly 180 directs the driving air flow so that the driving air flow introduced into the LiDar sensor L is injected onto the film element 300. The nozzle assembly 180 is disposed inside the housing 100. The nozzle assembly 180 may include a main body 182, a filter 184, a radial channel 186, and a nozzle 188.

An inlet of the nozzle assembly 180 may come into contact with the proximity portion 116 to communicate with the intake portion 110. Accordingly, the nozzle assembly 180 may direct the air, which has passed through the proximity portion 116, into the main body 182. In some implementations, the inlet of the nozzle assembly 180 may be provided with a filter 184 that may purify or filter the driving air flow.

The nozzle assembly 180 includes a plurality of radial channels 186. Each radial channel 186 may extend radially outward from the main body 182 of the nozzle assembly 180. In some implementations, the radial channels 186 may be formed within a certain range of the circumference of the LiDar sensor L and may be formed inside the rear side of the LiDar sensor L, i.e., inside the rear side of the housing 100.

A nozzle 188 is provided in each radial channel 186. The nozzle 188 is arranged to align with the hole 120 of the housing 100. A plurality of holes 120 may be provided in the housing 100. The holes 120 may be spaced apart from each other by a predetermined distance along the circumference of the housing 100. The driving air flow introduced through the intake portion 110 while the vehicle V is driving is introduced into the nozzle assembly 180. High-speed air may thus be injected onto the film element 300 through the nozzle 188 and the hole 120.

The housing 100 may also include a discharge portion 130. The discharge portion 130 allows the driving wind injected into the housing 100 to be discharged to the outside of the LiDar sensor L.

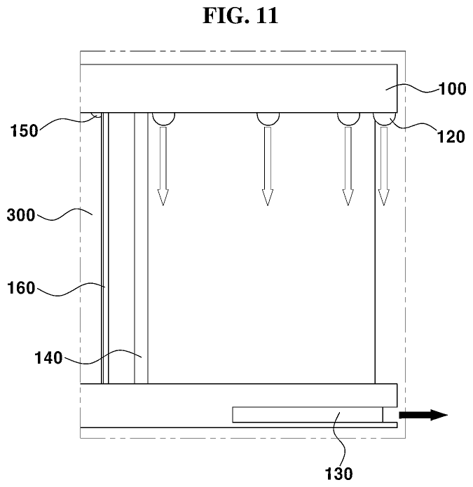

Hereinafter, the operation of the LiDar sensor cleaning device according to an embodiment of the present disclosure is additionally described with reference to FIG. 11.

Since the film element 300 is mounted on the LiDar sensor L, the LiDar sensor L may be primarily protected. When the contamination is not removed, even if the film element 300 is cleaned, the direct contamination of the LiDar sensor L may be prevented by replacing the film element 300.

The rotating element actuator 142 rotates the rotating element 140, and the rotational force of the rotating element 140 is transmitted to the film element 300. Accordingly, the film element 300 rotates with respect to the LiDar sensor L or the housing 100.

In this case, the cleaning fluid is injected onto the film element 300 from the injection nozzle 150 provided in the housing 100. The film element 300 is primarily cleaned by the injected cleaning fluid. Then the surface of the film element 300 is secondarily cleaned while being rubbed by the contact element 160 positioned in the front of the film element 300 in a rotation direction.

The injected cleaning fluid flows into the collector 170 provided under the housing 100 by gravity. The used cleaning fluid collected in collector 170 is filtered through the recovery line 172 to remove impurities and is directed to the storage 152 or the supply line 154.

While the vehicle V is travelling, the driving air flow may sequentially pass through the intake portion 110 and the nozzle assembly 180 and may be injected onto the film element 300 through the nozzle 188. The residue on the film element 300 may thus be removed and the film element 300 may be dried. The driving air flow is collected inside the housing 100 and, therefore, is discharged to the outside through the discharge unit 130 of the housing 100.

Although the cleaning of the LiDar sensor L is an example described in this specification, it may also be applied to an environmental sensor having a structure similar to that of the LiDar sensor L.

According to the present disclosure, a LiDar sensor cleaning device is provided that yields an efficient cleaning effect while integrating a plurality of cleaning fluid nozzles into one.

The LiDar sensor cleaning device according to the present disclosure recovers the used cleaning fluid and minimizes its usage, thereby enabling the maintenance cycle of the cleaning fluid and the reduction of the cleaning fluid storage capacity.

According to the present disclosure, a LiDar sensor cleaning device is provided that is capable of maximizing cleaning power through a nozzle assembly and a contact element such as a windshield wiper of a vehicle.

According to the present disclosure, a sensor cleaning device is provided that is capable of efficiently cleaning a sensor, such as a LiDar sensor.

According to the present disclosure, a sensor cleaning device is provided that yields excellent cleaning power.

The effects of the present disclosure are not limited to the above-mentioned effects. Other effects that are not mentioned herein may be understood by those having ordinary skill in the art from the following description.

It should be apparent to those having ordinary skill in the art to which the present disclosure pertains that the present disclosure is not limited to the above-mentioned embodiments and the accompanying drawings, but may be variously substituted, modified, and altered without departing from the scope and spirit of the present disclosure.

What is claimed is:

1. A sensor cleaning device comprising:
an environmental sensor; and
a film element disposed to surround the environmental sensor.

2. The sensor cleaning device of claim 1, wherein the environmental sensor is a LiDar sensor.

3. The sensor cleaning device of claim 1, wherein the film element is a polyamide material.

4. The sensor cleaning device of claim 1, further comprising:
a rotating element disposed on the environmental sensor to rotate the film element with respect to the environmental sensor.

5. The sensor cleaning device of claim 4, further comprising:
a contact element mounted on the environmental sensor to contact the film element.

6. The sensor cleaning device of claim 1, further comprising:
an injection nozzle mounted on the environmental sensor to inject a cleaning fluid onto the film element.

7. The sensor cleaning device of claim 6, further comprising:
a storage in which the cleaning fluid is stored; and
a supply line configured to place the storage in fluid communication with the injection nozzle.

8. The sensor cleaning device of claim 6, further comprising:
a collector provided in the environmental sensor to collect the cleaning fluid injected onto the film element.

9. The sensor cleaning device of claim 8, wherein the cleaning fluid in the collector is configured to be directed back to the injection nozzle.

10. The sensor cleaning device of claim 9, wherein the cleaning fluid in the collector is directed to the injection nozzle by a recovery line in fluid communication with the injection nozzle, and wherein the recovery line is provided with a filter element for filtering the cleaning fluid.

11. A sensor cleaning device comprising:
an environmental sensor;
a film element disposed to surround the environmental sensor and to be rotatable with respect to the environmental sensor; and
an injection nozzle provided in the environmental sensor and configured to inject a cleaning fluid onto the film element.

12. The sensor cleaning device of claim 11, further comprising:
a contact element provided on the environmental sensor and disposed to be in contact with the film element.

13. The sensor cleaning device of claim 12, wherein the contact element is at least one of a brush, a rubber element, or a sponge.

14. The sensor cleaning device of claim 11, further comprising:
a nozzle assembly configured to direct a driving air flow to the film element so that the driving air flow is introduced into the environmental sensor and is injected onto the film element while driving of a vehicle on which the environmental sensor is mounted.

15. The sensor cleaning device of claim 14, wherein the driving air flow is configured to be directed to a nozzle assembly through an intake portion provided in the environmental sensor, and wherein the nozzle assembly is disposed inside the environmental sensor and is in fluid communication with the intake portion.

16. The sensor cleaning device of claim 15, wherein the environmental sensor includes a discharge portion for discharging the driving air flow introduced into the environmental sensor.

17. The sensor cleaning device of claim 15, wherein the intake portion is configured to have a cross-sectional area that decreases toward the nozzle assembly.

18. The sensor cleaning device of claim 14, wherein the nozzle assembly includes a filter for filtering the driving air flow.

19. The sensor cleaning device of claim 14, wherein the nozzle assembly includes:
a plurality of radial channels for directing the driving air flow in a plurality of directions; and
a nozzle configured to inject the driving air flow from the one or more of the plurality of radial channels onto the film element.

20. The sensor cleaning device of claim 11, wherein the environmental sensor is a LiDar sensor.
